(19) United States
(12) Patent Application Publication
(10) Pub. No.: US 2006/0269271 A1
(43) Pub. Date: Nov. 30, 2006

(54) Method and device for controlling the exposure of a camera

(76) Inventor: Dieter Kokel, Meckenbeuren (DE)

Correspondence Address: CONTINENTAL TEVES, INC., ONE CONTINENTAL DRIVE, AUBURN HILLLS, MI, 48326-1581, US

(21) Appl. No.: 10/568,379

(22) PCT Filed: Jan. 20, 2004
(86) PCT No.: PCT/DE04/00067

§ 371 Date: Feb. 14, 2006

(30) Foreign Application Priority Data
Aug. 14, 2003 (DE) 10337357.8

(51) Int. Cl. G03B 7/00

(52) U.S. Cl. 396/213

(57) ABSTRACT

Disclosed is an exposure control method for a camera with at least one image sensor in which an image brightness set-point is preset and control is carried out with reference to this image brightness set-point it is provided to adjust the gradient of a substantially linear dependence of image brightness on illumination.

### BACKGROUND OF THE INVENTION

The present invention refers to an exposure control method for a camera with at least one image sensor in which an image brightness set-point is preset and control is carried out with reference to this image brightness set-point. The invention also refers to an exposure control device for a camera with at least one image sensor in which an image brightness set-point is preset and control is carried out with reference to this image brightness set-point. The invention also refers to a vehicle environment monitoring camera for motor vehicles.

In future, more and more motor vehicles will probably comprise systems for monitoring the immediate and further environment of the vehicle, such systems including systems that detect the motion of the vehicle as a whole and as a movable object in a traffic flow on the road. On the basis of these systems it is possible to drive and steer the vehicle in a calculated manner for the purpose of assisting the driver or navigating and to extend the functions of passenger protection systems including impact avoidance systems. Such systems also provide a basis for semiautonomous or even autonomous driving.

Suitable systems for monitoring the vehicle environment particularly include camera systems (vehicle environment monitoring camera) with image sensors on the basis of visible light or in the infrared range in addition to the known radar systems for longitudinal and sequential control.

There are no constant exposure conditions when consecutive images are recorded in the vehicle using a camera, e.g. for the purpose of tracking, by means of an image processing system. Said exposure conditions sometimes change very quickly, e.g. when driving into or out of a tunnel, and comprise a wide dynamic range from bright sunshine to darkness at night. However, the camera systems have to work in a sufficiently safe and precise manner under any circumstances, which requires the system to comprise a very high dynamic range. Conventional cheap cameras cannot cover said dynamic range by using one exposure setting only. Usually, the f-number and the exposure time are adjusted for this purpose.

Usually, cameras with LCD or CMOS sensors are used in the vehicle, wherein the exposure time corresponds to the period of time during which light is collected. In the following, said period of time is also called “integration time”. This integration time can be controlled purely electronically. Usually, there is no mechanical diaphragm. Instead, the use of LCD and CMOS camera sensors also includes the adjustment of intensification prior to supplying the signal to an A-D converter for further processing. Prior-art control methods, e.g. as described in DE 102 15 525 or U.S. 2003/098914, continuously measure the deviation from a set-point and try to keep this deviation as small as possible by continuous readjustment.

However, it is not always advantageous to control the brightness of each individual image of the consecutive images when evaluating the images by means of image processing systems. On the other hand, the set-point should be adjusted as quickly as possible when such control is necessary.

### SUMMARY OF THE INVENTION

The object of the invention is to provide a method and a device for controlling the exposure of the sensor by which an image contrast that is as high as possible can be adjusted in a quick and safe manner even when light conditions vary.

According to the invention, the object is achieved by carrying out control on the basis of a function of image brightness H depending on illumination B, wherein said illumination is the brightness that is actually optically present and arrives at the input side of the image sensor and that is integrated and/or intensified in an appropriate manner for the purpose of providing the brightness that is available for evaluation at the output side of the image sensor.

The measured brightness is controlled by adjusting gradient a, wherein image brightness H depends on illumination B (characteristic K). In one control step, a new gradient is determined from initial gradient α1, image brightness set-point Hsoll and current image brightness Hist according to the following formula: α2=α1*Hsoll/Hist.

The adaptation of the gradient immediately presets a new operating point so that no time-consuming continuous adjustment is necessary.

Gradient a is adjusted by presetting the integration time and/or intensification of the image sensor in an appropriate manner.

According to the invention it is preferably provided to preset a set-point range Hsoll1, Hsoll2 as an image brightness set-point Hsoll, wherein the interval between the set-points defines the operating range and thus the frequency of adaptations, thus defining an active operating range that is a wide range relative to the maximum theoretical operating range so that only a relatively small number of adaptations is necessary. This particularly ensures that it is usually not necessary to carry out a new adaptation within a preset time window once adaptation is finished. However, the concrete values depend very much on the dynamic range of the images to be captured and of the brightness variations.

The set-point range is preferably preset as follows: between 50% and 90% of the set-point for lower limit Hsoll1 and between 110% and 130% of the set-point for upper limit Hsoll2.

According to a further development of the invention it is provided to take a preset characteristic of characteristic K into consideration when determining new gradient α2.

According to the invention it is provided to determine new gradient α2—if characteristic K does not run through origin U—considering at least one offset value Offs1, Offs2 according to the following formula: α2=α1*(Hsoll−Offs1)/(Hist−Offs2).

The object of the invention is also achieved by means of a device in which a computer evaluates the images, wherein said computer substantially also controls exposure and image brightness.

Preferably, current image brightness Hist is adjusted to nominal image brightness Hsoll in one control step.

According to the invention it is provided to select specific, relevant pixels for the purpose of measuring image brightness and to carry out image brightness control substantially with reference to these regions.

According to the invention it is provided that the computer is provided for computing back (using an adjusted sensitivity) to the current image brightness of the scene the image of which is being formed and for providing this value to the system or to other systems.

All known and conceivable image acquisition sensors can be used as image sensors, in particular multisensor structures consisting of light-sensitive elements (scanning elements or pixels) that are arranged in a linear array or in the form of a matrix and receive their light from the inventive optical system. It is also possible to use Si image sensors (charge-coupled devices (CCD)). In CCD image sensors, the light that shines in via a transparent electrode generates charge carriers proportionally to intensity and exposure time, said charge carriers being collected in a “potential sump” (Si-SiO₂ barrier layer). By means of additional electrodes, these charges are shifted to an opaque zone and transported in “analogue” shift registers (bucket brigade principle) to an output register line by line, said output register being read out serially at a high clock rate. However, CMOS image sensors are used preferably. The use of CMOS sensors makes f-number control unnecessary and ensures constant contrast resolution across the complete brightness range. Advantageously, these sensors also ensure random access to individual pixels, wherein sensitivity is higher at the same time (higher reading rate). It is also possible to preprocess signals in the image sensor chip in a first preprocessing step.

In a particularly favourable embodiment of the invention it is provided to use sensor formats that are known per se, preferably CMOS camera sensors, substantially comprising one VGA resolution only. The use of such standard formats enables the system to be manufactured at a reasonable price since said standard formats are already available as mass-produced items.

However, the invention is explicitly not limited to the use of such standard sensors. For example, it is also provided to use special highly dynamic sensors in the inventive optical system. It is particularly provided to use so-called TFA (thin film on ASIC) chips as image sensors, such sensors providing a total dynamic range of more than 200 dB. When luminous intensity is low, in particular at dusk/dawn or at night, such systems can also be used as night vision devices, for example.

The inventive method and device are preferably used for a vehicle environment monitoring camera for motor vehicles.

### BRIEF DESCRIPTION OF THE DRAWINGS

In the following description, the invention will be explained in greater detail with reference to the accompanying drawings (FIG. 1 to FIG. 4).

FIG. 1 is a schematic representation of an image processing system;

FIG. 2 is a schematic representation of a course of the image brightness H of a sensor as a function of illumination B;

FIG. 3 shows schematically how current image brightness Hist is adjusted to an image brightness set-point (nominal image brightness) Hsoll in a tracking step;

FIG. 4 is a schematic representation of a third plot of a course of image brightness (characteristic K), wherein said characteristic does not run through the origin (zero point).

### DETAILED DESCRIPTION OF THE DRAWINGS

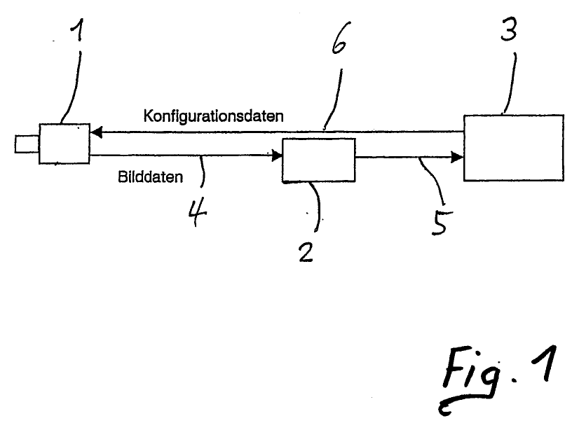

FIG. 1 is a schematic representation of an image processing system for a vehicle environment monitoring camera. The image processing system consists of the image recording device 1 (camera with sensor), the image data capturing device 2 (frame grabber), and the computer unit 3. The image data capturing device 2 receives image data 4 from the camera 1. The captured image data 5 are then transferred as output data to the computer 3 that evaluates said data. The computer also comprises a connection 6 to the camera 1 via which connection the computer can configure the camera 1.

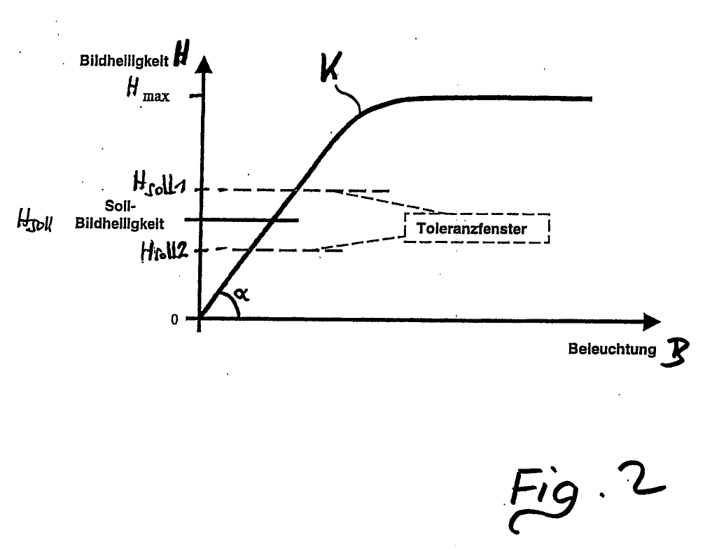

FIG. 2 is a schematic representation of a course of the image brightness H of a sensor as a function of illumination B (characteristic K). The manner of exposure control is based on the fact that the sensors, below the saturation threshold that ideally corresponds to maximum image brightness Hmax, are characterized by a substantially linear behaviour with reference to illumination, integration time and intensification.

The gradient α of the linear course is determined by the adjusted integration time and the adjusted intensification: α=η*integration time*intensification.

The constant of proportionality η includes the sensitivity of the sensor to light.

In order to adjust mean image brightness H, a set-point Hsoll is preset with reference to which control is carried out. The transmission of new control values to the sensor may affect image data transmission so that the number of control operations should be as small as possible. Therefore, a tolerance window between Hsoll1 and Hsoll2 is additionally preset within which tolerance window image brightness may vary without causing corrective control action.

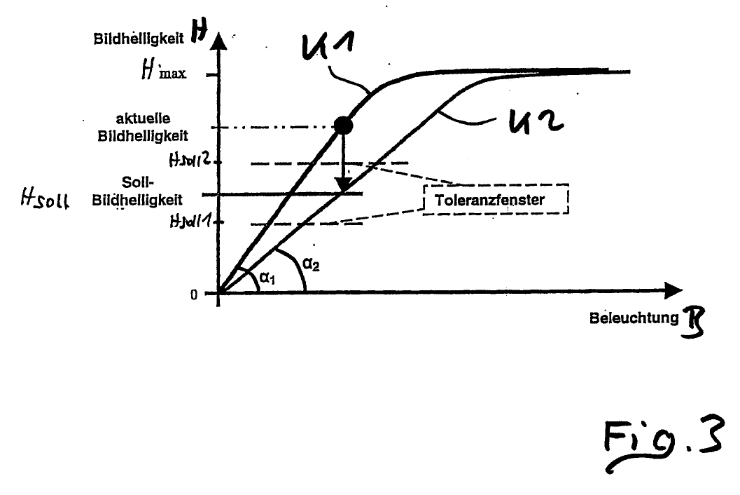

FIG. 3 shows schematically how current image brightness Hist is adjusted to image brightness set-point (nominal image brightness) Hsoll in a tracking step. If current image brightness Hist lies outside the tolerance window between Hsoll1 and Hsoll2, the gradient of characteristic K1 is changed in such a manner that current image brightness Hist corresponds to nominal image brightness Hsoll again. The new gradient is that of a new characteristic K2.

The nature of the invention consists in calculating new gradient α1 and adjusting current image brightness Hist to nominal image brightness Hsoll on the basis of that calculation by tracking in one control step.

On account of linear dependency, new gradient α2 is determined by multiplying old gradient α1 by the ratio that nominal image brightness Hsoll bears to current image brightness Hist: α2=α1•Hsoll/Hist

After determining new α2, either integration time or intensification are adapted at option or both are adapted in order to adjust new characteristic K2 as precisely as possible.

After the recognition of deviation, the new integration time and/or intensification of the sensor may be adjusted and thus is/are already active for the next image but one so that the new adjustment could be already carried out after 40 ms at a typical vertical refresh rate of 25 Hz.

When determining new gradient α2, the preset characteristic of a characteristic K of the dependence of image brightness H on illumination B is taken into consideration by appropriately adapting the gradient in the substantially linear portion. Offset values and the limits of the linear portion may also be taken into consideration. On principle, a more complex dependency could also be taken into consideration by an appropriately complex calculation, e.g. by a higher-order polynomial.

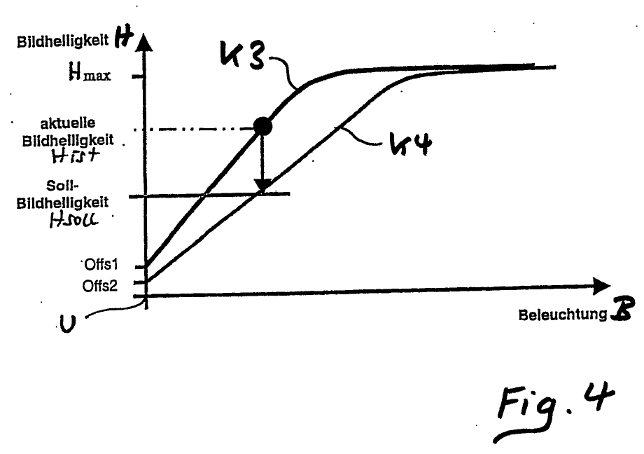

FIG. 4 is a schematic representation of characteristics K3, K4 that do not run through origin U. In this case, offset values Offs1 and Offs2 are deducted from the respective brightness values.

The invention is not limited to sensors with linear characteristics. With sensors having non-linear (e.g. logarithmic) characteristics, the lower branch of the characteristic can be approximated by a straight line with sufficient accuracy so that the present method can be applied to sensors with non-linear characteristics and the image brightness of sensors with non-linear characteristics can be adjusted to a set-point sufficiently well. Typically, sensors with non-linear characteristics cover a substantially higher dynamic range than sensors with linear characteristics so that the adjustment of image brightness to a set-point is less critical with sensors having non-linear characteristics than with linear sensors. Therefore, the increased inaccuracy of the calculation of control parameters occurring with a non-linear characteristic does not deteriorate image quality to an appreciable extent.

It is provided to control image brightness by means of the image evaluation computer or microcontroller or digital signal processor (DSP) so that current image brightness can be adjusted to nominal image brightness in one control step.

It is also provided to select relevant pixels for measuring image brightness. In certain applications, e.g. tracking, the region to be measured takes up only a part of the image so that exposure control is limited to pixels in this region, thereby ensuring optimum representation of said region.

It is also advantageously provided to use the sensor as a brightness sensor. If the computer controls the absolute adjustment of intensification and integration time, it can compute back to the current brightness of the imaged scene via the adjusted sensitivity and output this value as a measure of outside brightness. This value may be used for controlling the headlights of the vehicle, for example.

1-9. (canceled)

10. An exposure control method for a camera with at least one image sensor in which an image brightness set-point (Hsoll) is preset and control is carried out with reference to this image brightness set-point (Hsoll), the method comprising:
adjusting a gradient (α) by controlling at least one of an integration time or an intensification of an image sensor;
determining a new gradient from an initial gradient α1, image brightness set-point Hsoll and current image brightness Hist according to the formula: α2=α1*Hsoll/Hist.

11. A method according to claim 10, wherein image brightness Hist is compared with a tolerance range (Hsoll1, Hsoll2) around image brightness set-point (Hsoll); and a new gradient α2 is preset in one control step only if image brightness Hist lies outside said tolerance range (Hsoll1, Hsoll2) around image brightness set-point (Hsoll).

12. A method according to claim 10, wherein a preset characteristic of a characteristic (K) of the dependence of image brightness (H) on illumination (B) is taken into consideration when determining new gradient α2.

13. A method according to claim 12, wherein characteristic K does not run through origin U and new gradient α2 is determined considering at least one offset value Offs1 according to the following formula: α2=α1*(Hsoll−Offs1)/(Hist−Offs1).

14. A method according to claim 13, wherein for each gradient (α2, α1) a respective offset value (Offs1, Offs2) is provided and new gradient α2 is determined considering said respective offset values according to the following formula: α2=α1*(Hsoll−Offs1)/(Hist−Offs2).

15. An exposure control device for a camera with at least one image sensor in which an image brightness set-point Hsoll is preset and control is carried out with reference to this image brightness set-point Hsoll, the device comprising:
a computer for evaluating images and for substantially controling exposure and image brightness.

16. A device according to claim 15, wherein specific, relevant pixels are selected to measure an image brightness and image brightness control is substantially carried out with reference to selected regions.

17. A device according to claim 15, wherein the computer uses an adjusted sensitivity for the current image brightness of a scene the image of which is being formed and for providing this value to a system.

18. A device according to claim 15, wherein the device is used in vehicle environment monitoring camera for motor vehicles.
